(19) United States
(12) Patent Application Publication
(10) Pub. No.: US 2017/0097514 A1
(43) Pub. Date: Apr. 6, 2017

(54) OPTICAL LOW-PASS FILTER AND IMAGING DEVICE PROVIDED WITH OPTICAL LOW-PASS FILTER

(71) Applicant: Daishinku Corporation, Kakogawa-shi, Hyogo (JP)

(72) Inventor: Tatsuya SHOGAKI, Kakogawa-shi (JP)

(73) Assignee: Daishinku Corporation, Kakogawa-shi, Hyogo (JP)

(21) Appl. No.: 15/125,182

(22) PCT Filed: Feb. 18, 2015
(86) PCT No.: PCT/JP2015/054460

§ 371 Date: Sep. 11, 2016

(30) Foreign Application Priority Data
Mar. 19, 2014 (JP) 2014-056332

(51) Int. Cl. G02B 27/28; G02B 5/30

(52) U.S. Cl. CPC G02B 27/283; G02B 27/288; G02B 5/3083

(57) ABSTRACT

An optical low-pass filter (30) includes a vertically splitting birefringent plate (31), a 45° splitting birefringent plate (32), and a 135° splitting birefringent plate (33). The 45° splitting birefringent plate (32) and the 135° splitting birefringent plate (33) are adjacent to each other. The thickness of the 45° splitting birefringent plate (32) is approximately equal to the thickness of the 135° splitting birefringent plate (33). The thicknesses of the 45° splitting birefringent plate (32) and the 135° splitting birefringent plate (33) are each less than the thickness of the vertically splitting birefringent plate (31). The position (point Pal) of incidence of an incident beam (L) on the vertically splitting birefringent plate (31) overlaps with the approximate center of a square split pattern (points P11, P12, P13, and P14) when viewed from the incident beam side.

### TECHNICAL FIELD

The present invention relates to an optical low-pass filter and an imaging device provided with the optical low-pass filter, and in particular, relates to an optical filter such as an optical low-pass filter including three birefringent plates that split an incident beam into four outgoing beams positioned at corners of a quadrangular split pattern, and an imaging device using the optical filter.

### BACKGROUND ART

As a conventional technique, Patent Literature 1 discloses optical low-pass filters including horizontally splitting birefringent plates that split incident beams (unit beams) in a horizontal direction, depolarizers such as quarter-wave plates, and vertically splitting birefringent plates that split the incident beams in a vertical direction, and also discloses imaging devices. In each of these optical low-pass filters, the horizontally splitting birefringent plate, the depolarizer, and the vertically splitting birefringent plate are adjacent to one another in this order starting from the incident beam side. Such optical low-pass filters are disposed ahead of imaging elements such as CCDs to cut off and attenuate spatial frequency components associated with spurious signals generated in the imaging elements, thereby improve (reduce) the Moiré phenomenon.

The optical low-pass filters described above are each configured to split the incident beam into four outgoing beams positioned at corners of a quadrangular split pattern. Specifically, the beam (unit beam) incident on the horizontally splitting birefringent plate is split by birefringence into two beams, an ordinary beam and an extraordinary beam split in the horizontal direction, and the beams enter the depolarizer. The ordinary beam and the extraordinary beam incident on the depolarizer are depolarized by the depolarizer, and the depolarized beams enter the vertically splitting birefringent plate. The two beams incident on the vertically splitting birefringent plate are split into four beams, two ordinary beams and two extraordinary beams split in the vertical direction, and the four beams are emitted. Accordingly, the beams emitted from the optical low-pass filter are the four beams (unit beams) positioned at the corners of the quadrangular split pattern. However, the optical low-pass filters described above cannot give desired quadrangular split patterns with incident beams in a particular wavelength range in some cases due to the wavelength dependence of the phase differences of the depolarizers.

Regarding the matter described above, Patent Literature 1 discloses optical low-pass filters that can give desired quadrangular split patterns. A configuration of such optical low-pass filters will be described with reference to FIG. 28 and FIG. 29.

As shown in FIG. 28, a conventional optical low-pass filter 500 includes a horizontally splitting birefringent plate 501 that splits an incident beam in a horizontal direction (X direction), a +45° splitting birefringent plate 502 that splits the incident beam in a direction (+45° direction) at 45° counterclockwise to the horizontal direction, and a −45° splitting birefringent plate 503 that splits the incident beam in a direction (−45° direction) at 45° clockwise to the horizontal direction. In this optical low-pass filter 500, the horizontally splitting birefringent plate 501, the +45° splitting birefringent plate 502, and the −45° splitting birefringent plate 503 are adjacent to one another in this order starting from the incident beam side.

An incident beam L on a point Pa on the horizontally splitting birefringent plate 501 is split by birefringence into two beams, an ordinary beam LO1 and an extraordinary beam LE1 split in the horizontal direction. In other words, as shown in FIG. 29, the beam (shaded portion) incident on the point Pa is split in the direction of the arrow A (horizontal direction) into beams on two points (points Pb and Pc).

Next, as shown in FIG. 28, the ordinary beam LO1 incident on the point Pb on the +45° splitting birefringent plate 502 is split by birefringence into two beams, an ordinary beam LO2 and an extraordinary beam LE2 split in the +45° direction. The extraordinary beam LE1 incident on the point Pc on the +45° splitting birefringent plate 502 is split by birefringence into two beams, an ordinary beam LO3 and an extraordinary beam LE3 split in the +45° direction. In other words, as shown in FIG. 29, the beams incident on the respective points Pb and Pc are each split in the direction of the arrows B (+45° direction), and thus beams on four points (points Pd, Pe, Pf, and Pg) are emitted.

Next, as shown in FIG. 28, the extraordinary beam LE2 incident on the point Pd on the −45° splitting birefringent plate 503 is emitted as an ordinary beam LO4 (point P1). Similarly, the extraordinary beam LE3 incident on the point Pe on the −45° splitting birefringent plate 503 is emitted as an ordinary beam LO5 (point P2). On the other hand, the ordinary beam LO2 incident on the point Pf on the −45° splitting birefringent plate 503 is shifted in the −45° direction and emitted as an extraordinary beam LE4 (point P3). Similarly, the ordinary beam LO3 incident on the point Pg on the −45° splitting birefringent plate 503 is shifted in the −45° direction and emitted as an extraordinary beam LE5 (point P4). In other words, as shown in FIG. 29, the beams incident on the respective points Pf and Pg are each shifted in the direction of the arrows C (−45° direction), and thus beams on four points (points P1, P2, P3, and P4) are emitted. Accordingly, the incident beam L is split into four outgoing beams (unit beams) positioned at corners of a quadrangular split pattern constituted of the points P1, P2, P3, and P4.

### CITATION LIST

### Patent Literature

PTL1: Japanese Patent No. 3829717

### SUMMARY OF INVENTION

### Technical Problem

However, in the conventional optical low-pass filter 500, the position (point Pa) of incidence of the incident beam L on the horizontally splitting birefringent plate 501 is positioned outside the quadrangular split pattern obtained by connecting the points P1, P2, P3, and P4 when viewed from the incident beam side (optical axis direction), as shown in FIG. 28 and FIG. 29. For this reason, there is a disadvantage in that the positional relation between the position of incidence of the incident beam on the optical low-pass filter and the position of the split pattern changes when the overall optical low-pass filter rotates by a certain angle about the optical axis, for example. The points P1 to P4 rotate about the point Pa, for example. Accordingly, there is a problem in that precision of the position of the split pattern in relation to the position of incidence of the incident beam is degraded.

In view of the problems above, the present invention has an object to provide an optical low-pass filter that can improve the precision of the position of a split pattern in relation to the position of incidence of an incident beam, and an imaging device.

### Solution to Problem

As means for solving the problems above, the optical low-pass filter according to the present invention is configured as follows.

That is, the optical low-pass filter according to the present invention is premised on the configuration that includes three birefringent plates configured to split an incident beam into four outgoing beams positioned at corners of a quadrangular split pattern. In the optical low-pass filter according to the present invention, the three birefringent plates are a first birefringent plate, a second birefringent plate, and a third birefringent plate. The first birefringent plate is configured to split the incident beam in a vertical direction or a horizontal direction. The second birefringent plate is configured to perform splitting in a direction at 135° counterclockwise to the split direction of the first birefringent plate. The third birefringent plate is configured to perform splitting in a direction at 135° clockwise to the split direction of the first birefringent plate. The second birefringent plate and the third birefringent plate are adjacent to each other. The thickness of the second birefringent plate is approximately equal to the thickness of the third birefringent plate. The thickness of the second birefringent plate and the thickness of the third birefringent plate are each less than the thickness of the first birefringent plate. The position of incidence of the incident beam on the birefringent plates overlaps with the approximate center or a portion adjacent to the center of a quadrangular split pattern when viewed from the incident beam side.

The optical low-pass filter having this configuration can form a split pattern with the position of incidence of the incident beam being its center when viewed from the incident beam side toward the outgoing beam side. This configuration enables the position of incidence of the incident beam to be positioned to overlap with the approximate center or the portion adjacent to the center of the quadrangular split pattern. The amount of displacement of the position of incidence of the incident beam from the center of the quadrangular split pattern can be thus smaller than in the case in which the position of incidence of the incident beam is positioned outside the quadrangular split pattern. Accordingly, the amount of change of the position of incidence of the incident beam in relation to the position of the split pattern can be reduced when the overall optical low-pass filter rotates by a certain angle about the optical axis. The precision of the position of the split pattern in relation to the position of incidence of the incident beam can be thus improved.

Combinations of the order of arrangement of the first, the second, and the third birefringent plates according to the present invention starting from the incident beam side include the order of the first, the second, and the third birefringent plates, the order of the first, the third, and the second birefringent plates, the order of the second, the third, and the first birefringent plates, and the order of the third, the second, and the first birefringent plates.

Specific configurations of the present invention include a plurality of configurations below.

In the optical low-pass filter according to the present invention, preferably, the thickness of the second birefringent plate and the thickness of the third birefringent plate may be each (1/√2) times as large as the thickness of the first birefringent plate. The incident beam may be split by the birefringent plates into four outgoing beams positioned at corners of a square split pattern. The position of incidence of the incident beam on the birefringent plates may overlap with the approximate center of the square split pattern when viewed from the incident beam side. This configuration causes the position of incidence of the incident beam to overlap with the approximate center of the square split pattern, and can prevent the position of incidence of the incident beam from changing in relation to the position of the square split pattern when the overall optical low-pass filter rotates about the optical axis, in addition to the operations and effects described above.

In the optical low-pass filter according to the present invention, preferably, the end points of arrow-shaped symbols respectively representing the split direction of the first birefringent plate, the split direction of the second birefringent plate, and the split direction of the third birefringent plate may form an approximate triangle when the arrow-shaped symbols are superimposed on one another and the end points are connected to one another. This configuration enables the position of incidence of the incident beam to be positioned to overlap with the approximate center or the portion adjacent to the center of the quadrangular split pattern easily by selecting the split direction (orientation of the optic axis) of each of the birefringent plates to position each of the birefringent plates so that the end points of the arrow-shaped symbols for the split directions of the birefringent plates form an approximate triangle when connected to one another, in addition to the operations and effects described above.

In addition, as means for solving the problems above, an imaging device according to the present invention is configured as follows.

That is, the imaging device according to the present invention is premised on the configuration that includes the optical low-pass filter according to any one of claims 1 to 3 and an imaging element. The imaging element includes at least four pixels. The pixels are arranged along the row direction and the column direction. In the imaging device according to the present invention, the four outgoing beams split by the birefringent plates are respectively emitted toward four pixels of the imaging element. The position of incidence of the incident beam on the birefringent plates overlaps with the approximate center or a portion adjacent to the center of the four pixels of the imaging element when viewed from the incident beam side.

With the imaging device having this configuration, the amount of displacement of the position of incidence of the incident beam in relation to the center (intersection point of borders of adjacent pixels among the four pixels) of the four pixels can be reduced while the amount of displacement of the position of incidence of the incident beam from the center of the split pattern is reduced, in addition to the operations and effects described above. Moiré can be thus reduced while the precision of the position of the split pattern and the positions of the pixels of the imaging element in relation to the position of incidence of the incident beam is improved.

Specific configurations of the present invention include a configuration below.

Preferably, the imaging device according to the present invention may further include a coupling optical unit that the incident beam is configured to enter. The coupling optical unit, the three birefringent plates, and the imaging element may be disposed in this order starting from the incident beam side. This configuration can give an imaging device with improved precision of the position of incidence of the incident beam from the object side in relation to the position of the center of the four pixels of the imaging element, and, if the imaging device is installed as an onboard camera on a car, the positions of traffic lane lines, road signs, pedestrians, and other objects around the car can be more accurately recognized, in addition to the operations and effects described above.

### Advantageous Effects of Invention

As described above, the optical low-pass filter and the imaging device according to the present invention can improve the precision of the position of the split pattern in relation to the position of incidence of the incident beam.

### BRIEF DESCRIPTION OF DRAWINGS

FIG. 1 is a schematic configuration diagram of an imaging device according to a first embodiment.

FIG. 2 is an exploded perspective view of an optical low-pass filter according to the first embodiment.

FIG. 3 is a schematic diagram for illustrating a split (shift) pattern of an incident beam.

FIG. 4 is a diagram illustrating the split direction of a vertically splitting birefringent plate.

FIG. 5 is a schematic diagram for illustrating a split pattern through the vertically splitting birefringent plate.

FIG. 6 is a diagram illustrating the split direction of a 45° splitting birefringent plate.

FIG. 7 is a schematic diagram for illustrating a split pattern through the 45° splitting birefringent plate.

FIG. 8 is a diagram illustrating the split direction of a 135° splitting birefringent plate.

FIG. 9 is a schematic diagram for illustrating a shift pattern through the 135° splitting birefringent plate.

FIG. 10 is a schematic diagram illustrating a shape formed by coupling the end points of arrows representing the respective split directions of the birefringent plates shown in FIG. 4, FIG. 6, and FIG. 8.

FIG. 11 is a schematic diagram illustrating a shape formed by continuously coupling arrows representing the respective split (shift) directions of the birefringent plates shown in FIG. 3, FIG. 5, FIG. 7, and FIG. 9.

FIG. 12 is a diagram illustrating positional relations between the position of incidence of the incident beam, the split pattern, and pixels.

FIG. 13 is an exploded perspective view of an optical low-pass filter according to a second embodiment.

FIG. 14 is a schematic diagram for illustrating a split (shift) pattern of an incident beam.

FIG. 15 is a schematic diagram for illustrating a split pattern through the vertically splitting birefringent plate.

FIG. 16 is a schematic diagram for illustrating a split pattern through the 135° splitting birefringent plate.

FIG. 17 is a schematic diagram for illustrating a shift pattern through the 45° splitting birefringent plate.

FIG. 18 is an exploded perspective view of an optical low-pass filter according to a third embodiment.

FIG. 19 is a schematic diagram for illustrating a split (shift) pattern of an incident beam.

FIG. 20 is a schematic diagram for illustrating a split pattern through the 45° splitting birefringent plate.

FIG. 21 is a schematic diagram for illustrating a shift pattern through the 135° splitting birefringent plate.

FIG. 22 is a schematic diagram for illustrating a split pattern through the vertically splitting birefringent plate.

FIG. 23 is an exploded perspective view of an optical low-pass filter according to a fourth embodiment.

FIG. 24 is a schematic diagram for illustrating a split (shift) pattern of an incident beam.

FIG. 25 is a schematic diagram for illustrating a split pattern through the 135° splitting birefringent plate.

FIG. 26 is a schematic diagram for illustrating a shift pattern through the 45° splitting birefringent plate.

FIG. 27 is a schematic diagram for illustrating a split pattern through the vertically splitting birefringent plate.

FIG. 28 is an exploded perspective view of an optical low-pass filter according to a conventional example.

FIG. 29 is a schematic diagram for illustrating a split (shift) pattern of an incident beam.

### DESCRIPTION OF EMBODIMENTS

The following describes embodiments of the present invention on the basis of the drawings.

### FIRST EMBODIMENT

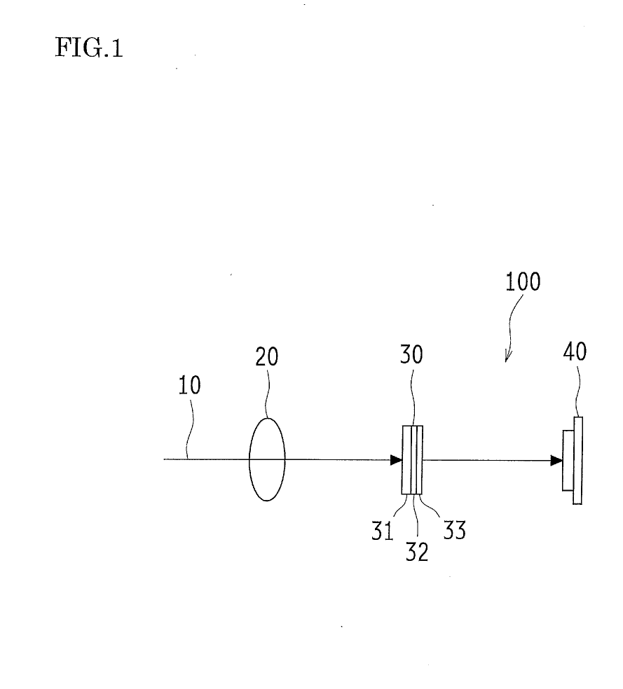

As shown in FIG. 1, an imaging device 100 according to a first embodiment includes a lens 20 serving as a coupling optical system that a beam (unit beam) enters from the outside object side along an optical axis 10, an optical low-pass filter 30 made of quartz crystal having rectangular major surfaces, and an imaging element 40 such as a CCD and a CMOS in this order. The lens 20 is an example of a “coupling optical unit” of the present invention.

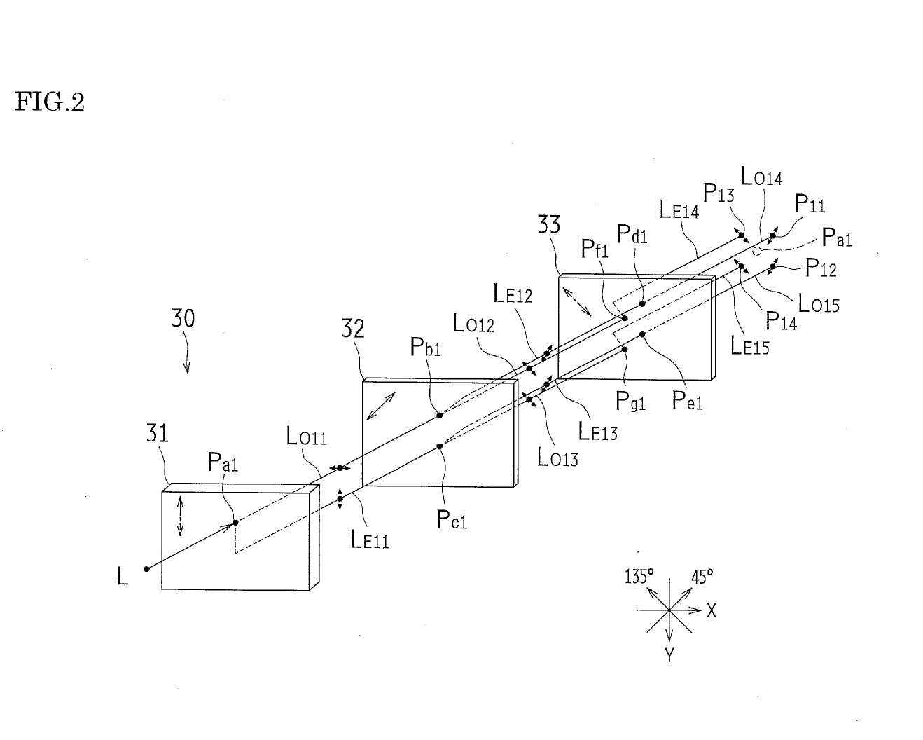

As shown in FIG. 2, the optical low-pass filter 30 includes a vertically splitting birefringent plate 31 that is cut in such a manner as to split an incident beam (unit beam) in a vertical direction (Y direction), a 45° splitting birefringent plate 32 that is cut in such a manner as to split the incident beam in a 45° direction, and a 135° splitting birefringent plate 33 that is cut in such a manner as to split the incident beam in a 135° direction. The vertically splitting birefringent plate 31 is an example of a “first birefringent plate” of the present invention, the 45° splitting birefringent plate 32 is an example of a “second birefringent plate” of the present invention, and the 135° splitting birefringent plate 33 is an example of a “third birefringent plate” of the present invention.

In the present embodiment, the description supposes the X direction (horizontal direction) in FIG. 2 to be the baseline (0°), a direction at 45° counterclockwise to the baseline to be the 45° direction, a direction at 135° counterclockwise to the baseline to be the 135° direction, and a direction at 90° clockwise to the baseline to be the vertical direction (Y direction), for the purpose of illustration.

In other words, the 45° splitting birefringent plate 32 has a function of splitting the incident beam in a direction at 135° counterclockwise to the split direction (Y direction) of the vertically splitting birefringent plate 31. The 135° splitting birefringent plate 33 has a function of splitting the incident beam in a direction at 135° clockwise to the split direction (Y direction) of the vertically splitting birefringent plate 31. The split direction of the 45° splitting birefringent plate 32 is orthogonal to the split direction of the 135° splitting birefringent plate 33.

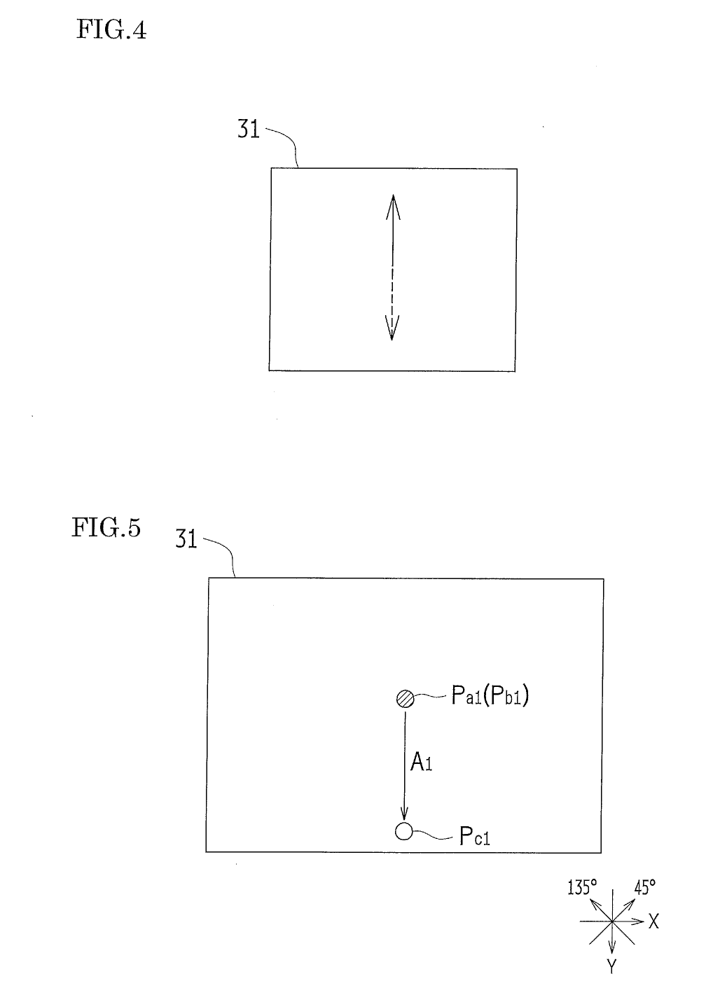

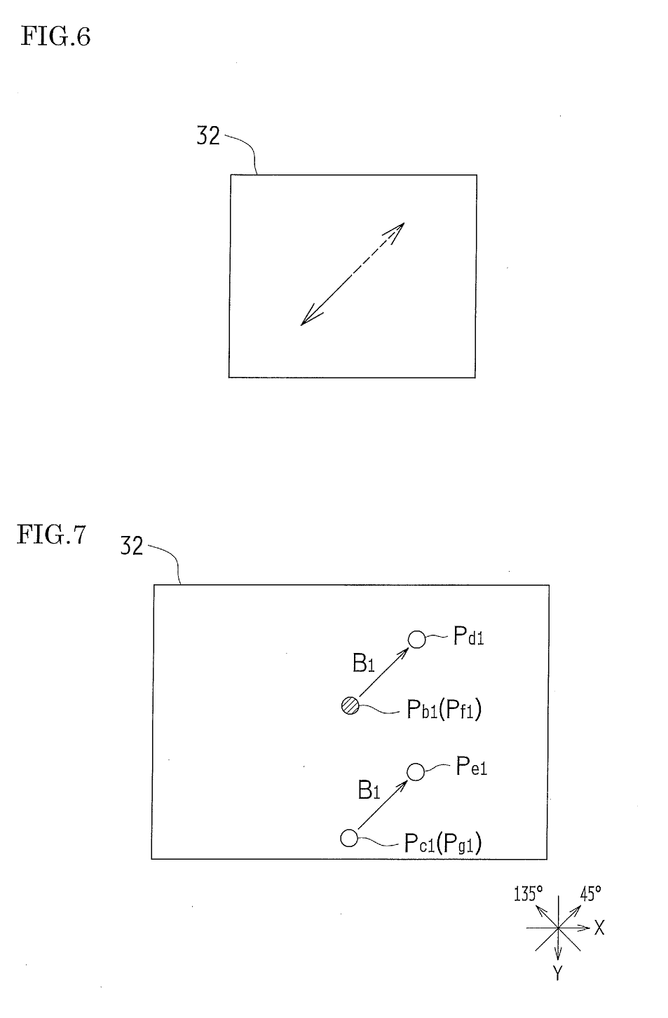

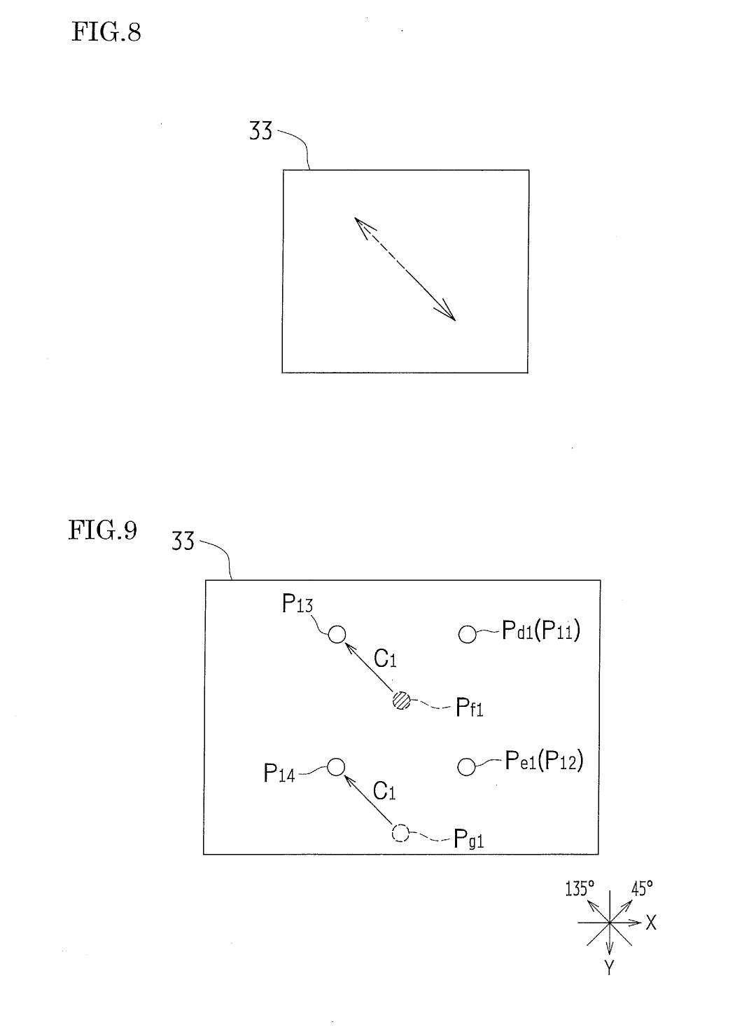

As shown in FIG. 2 (FIG. 4, FIG. 6, and FIG. 8), the split direction is inclined at a predetermined angle also in the thickness direction of each of the birefringent plates 31 (32 and 33), from the solid arrow toward the dashed arrow shown for each of the birefringent plates 31 (32 and 33) (from the near-side major surface (near side of the plane of the paper) toward the major surface of the traveling direction (far side of the plane of the paper) of each of the birefringent plates).

In the optical low-pass filter 30, the vertically splitting birefringent plate 31, the 45° splitting birefringent plate 32, and the 135° splitting birefringent plate 33 are adjacent to one another in this order starting from the incident beam side. The thickness of the 45° splitting birefringent plate 32 is approximately equal to the thickness of the 135° splitting birefringent plate 33. The thicknesses of the 45° splitting birefringent plate 32 and the 135° splitting birefringent plate 33 are each less than the thickness of the vertically splitting birefringent plate 31. Specifically, the thicknesses of the 45° splitting birefringent plate 32 and the 135° splitting birefringent plate 33 are each (1/√2) times as large as the thickness of the vertically splitting birefringent plate 31. In other words, the thickness of the 45° splitting birefringent plate 32 (thickness of the 135° splitting birefringent plate 33):the thickness of the vertically splitting birefringent plate 31 is equal to 1:√2.

The optical low-pass filter 30 described above splits the incident beam on the optical low-pass filter 30 into a square four-point split pattern. The position of incidence of the incident beam on the vertically splitting birefringent plate 31 overlaps with the approximate center of the square four-point split pattern when viewed from the incident beam side.

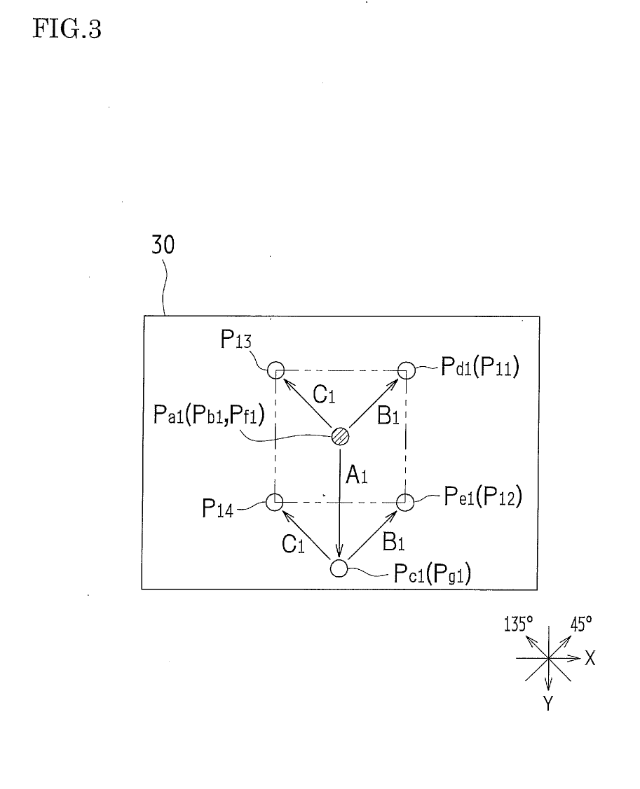

Next, splitting by the optical low-pass filter 30 will be described in detail. As shown in FIG. 2, an incident beam L on a point Pa1 on the vertically splitting birefringent plate 31 is split by birefringence into two beams (unit beams), an ordinary beam LO11 and an extraordinary beam LE11. In this case, the extraordinary beam LE11 is split in the vertical direction (Y direction). In other words, as shown in FIG. 3 to FIG. 5, the beam (shaded portion) incident on the point Pa1 is split in the direction of the arrow A1 (vertical direction) into beams on two points (points Pb1 and Pc1). As shown in FIG. 2, the arrows on the paths of the ordinary beam and the extraordinary beam respectively represent the orientations of the planes of polarization of the beams. For example, the orientation of the plane of polarization of the ordinary beam LO11 is the horizontal direction (X direction), and the orientation of the plane of polarization of the extraordinary beam LE11 is the vertical direction (Y direction).

Next, the ordinary beam LO11 incident on the point Pb1 on the 45° splitting birefringent plate 32 is split by birefringence into two beams (unit beams), an ordinary beam LO12 and an extraordinary beam LE12. In this case, the extraordinary beam LE12 is split in the 45° direction. The extraordinary beam LE11 incident on the point Pc1 on the 45° splitting birefringent plate 32 is split by birefringence into two beams (unit beams), an ordinary beam LO13 and an extraordinary beam LE13. In this case, the extraordinary beam LE13 is split in the 45° direction. In other words, as shown in FIG. 3, FIG. 6, and FIG. 7, the beams incident on the points Pb1 and Pc1 are each split in the direction of the arrows B1 (45° direction), and thus the beams are split into beams on four points (points Pd1, Pe1, Pf1, and Pg1). As shown in FIG. 2, the orientations of the planes of polarization of the ordinary beam LO12 and the ordinary beam LO13 are both the 135° direction, and the orientations of the planes of polarization of the extraordinary beam LE12 and the extraordinary beam LE13 are both the 45° direction.

Next, the extraordinary beam LE12 incident on the point Pd1 on the 135° splitting birefringent plate 33 is emitted as an ordinary beam LO14 (point P11). Similarly, the extraordinary beam LE13 incident on the point Pe1 on the 135° splitting birefringent plate 33 is emitted as an ordinary beam LO15 (point P12). On the other hand, the ordinary beam LO12 incident on the point Pf1 on the 135° splitting birefringent plate 33 is shifted in the 135° direction and emitted as an extraordinary beam LE14 (point P13). Similarly, the ordinary beam LO13 incident on the point Pg1 on the 135° splitting birefringent plate 33 is shifted in the 135° direction and emitted as an extraordinary beam LE15 (point P14). In other words, as shown in FIG. 3, FIG. 8, and FIG. 9, the beams incident on the points Pf1 and Pg1 are each shifted in the direction of the arrows C1 (135° direction), and thus beams on four points (points P11, P12, P13, and P14) are emitted. As shown in FIG. 2, the orientations of the planes of polarization of the ordinary beam LO14 and the ordinary beam LO15 are both the 45° direction, and the orientations of the planes of polarization of the extraordinary beam LE14 and the extraordinary beam LE15 are both the 135° direction.

Accordingly, the incident beam L is split into four outgoing beams (unit beams) positioned at corners of a square split pattern obtained by connecting the points P11, P12, P13, and P14. In the first embodiment, as shown in FIG. 2 and FIG. 3, the position Pa1 of incidence of the incident beam L (shaded portion in FIG. 3) on the vertically splitting birefringent plate 31 overlaps with the center of the square split pattern when viewed from the incident beam side toward the outgoing beam side. Specifically, the position (point Pa1) of incidence of the incident beam L overlaps with the intersection point of the diagonal line connecting the point P11 and the point P14 and the diagonal line connecting the point P12 and the point P13 of the split pattern.

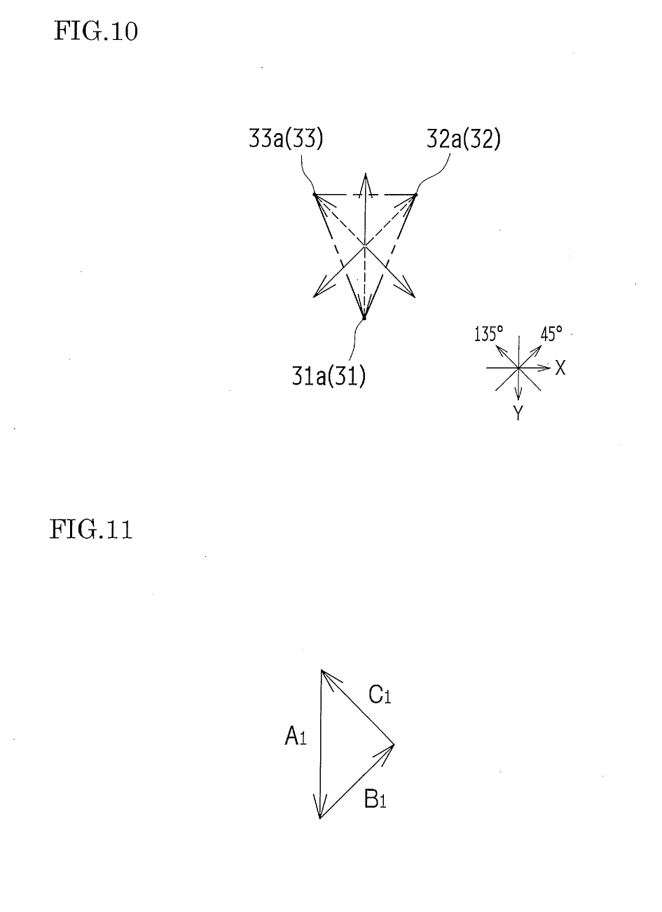

As shown in FIG. 10, the end points of arrows respectively representing the split directions of the vertically splitting birefringent plate 31, the 45° splitting birefringent plate 32, and the 135° splitting birefringent plate 33 form an approximate triangle when the arrows are superimposed on one another and the end points are connected to one another by straight lines. Specifically, as shown in FIG. 10, end points 31a, 32a, and 33a of the arrows respectively representing the split directions (directions indicated by the dashed arrows) of the vertically splitting birefringent plate 31, the 45° splitting birefringent plate 32, and the 135° splitting birefringent plate 33, which are respectively shown in FIG. 4, FIG. 6, and FIG. 8, form an isosceles triangle when the arrows are superimposed on one another and the end points are connected to one another by straight lines.

As shown in FIG. 2, FIG. 3, and FIG. 11, the split or shift directions of the extraordinary beams among the beams that experience birefringence by the birefringent plates form an approximate triangle when viewed continuously from the incident beam side in the order of transmission. Specifically, as shown in FIG. 2 and FIG. 3, the split direction of the extraordinary beam LE11 at the vertically splitting birefringent plate 31 is the vertical direction (Y direction) (arrow A1 shown in FIG. 3). The split directions of the extraordinary beam LE12 and the extraordinary beam LE13 at the 45° splitting birefringent plate 32 are both the 45° direction (arrows B1 shown in FIG. 3). The shift directions of the extraordinary beam LE14 and the extraordinary beam LE15 at the 135° splitting birefringent plate 33 are both the 135° direction (arrows C1 shown in FIG. 3). The end points and the start points of these arrows A1, B1, and C1 are coupled to one another in the order of arrangement of the birefringent plates. The shape formed by coupling is an approximate triangle. Specifically, as shown in FIG. 3 and FIG. 11, the end point of the arrow A1 is coupled to the start point of the arrow B1, the start point of the arrow C1 is moved to and coupled to the end point of the arrow B1, and the end point of the arrow C1 is coupled to the start point of the arrow A1. The shape formed by coupling the arrows A1, B1, and C1 is an isosceles triangle.

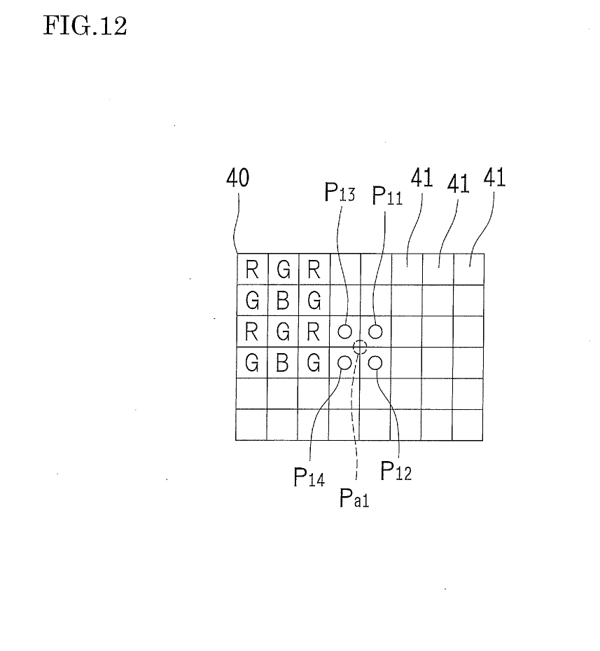

As shown in FIG. 12, the imaging element 40 includes a plurality of square pixels 41 along the row direction and the column direction. On these pixels 41, a color filter array is disposed in which RGB (red, green, and blue) filters are regularly arranged. Each of the pixels 41 recognizes color information of one of RGB.

The four outgoing beams (points P11, P12, P13, and P14) (see FIG. 2) having been transmitted through the optical low-pass filter 30 are respectively emitted toward four of the pixels 41 of the imaging element 40. The position (point Pa1) of incidence of the incident beam L on the optical low-pass filter 30 overlaps with the center of the four pixels 41 of the imaging element 40 when viewed from the incident beam side. Specifically, the position (point Pa1) of incidence of the incident beam L overlaps with the intersection point of borders of adjacent pixels 41 among the four pixels 41.

As described above, the optical low-pass filter 30 (imaging device 100) according to the first embodiment provides effects as listed below.

In the first embodiment, the position (point Pa1) of incidence of the incident beam L on the vertically splitting birefringent plate 31 overlaps with the approximate center of the square split pattern (points P11, P12, P13, and P14) when viewed from the incident beam side, as described above. This configuration can form a split pattern with the position of incidence of the incident beam L being its center when viewed from the incident beam side toward the outgoing beam side. Accordingly, the position of incidence of the incident beam L can be positioned to overlap with the center of the square split pattern. The amount of displacement of the position of incidence from the center of the square split pattern can be thus smaller than in the case in which the position of incidence is positioned outside the square split pattern. Thus, the amount of change of the position of incidence of the incident beam L in relation to the position of the split pattern can be reduced when the overall optical low-pass filter 30 rotates by a certain angle about the optical axis. Accordingly, the precision of the position of the split pattern (points P11, P12, P13, and P14) in relation to the position (point Pa1) of incidence of the incident beam L can be improved.

In the first embodiment, as described above, the thicknesses of the 45° splitting birefringent plate 32 and the 135° splitting birefringent plate 33 are each (1/√2) times as large as the thickness of the vertically splitting birefringent plate 31. The incident beam L is split by the birefringent plates 31 (32 and 33) into four outgoing beams positioned at the corners of the square split pattern. The position (point Pa1) of incidence of the incident beam L on the vertically splitting birefringent plate 31 overlaps with the approximate center of the square split pattern (points P11, P12, P13, and P14) when viewed from the incident beam side. Thus, since the position of incidence of the incident beam L overlaps with the approximate center of the square split pattern, the position (point Pa1) of incidence of the incident beam L can be prevented from changing in relation to the position of the square split pattern (points P11, P12, P13, and P14) when the optical low-pass filter 30 rotates about the optical axis, in addition to the operations and effects described above.

The first embodiment has described the example in which the thickness of the 45° splitting birefringent plate 32 (thickness of the 135° splitting birefringent plate 33):the thickness of the vertically splitting birefringent plate 31 is equal to 1:√2, but the present invention is not limited to this example. For example, the ratio can be changed in the range that the thickness of the 45° splitting birefringent plate 32 (thickness of the 135° splitting birefringent plate 33):the thickness of the vertically splitting birefringent plate 31 is equal to 0.95 to 1.05:1.34 to 1.48. The above range has been obtained by preliminary simulation, experimental results, and the like. Effects similar to the case of the ratio of 1:√2 can be obtained in this range. In other words, the position of incidence of the incident beam can be positioned at the approximate center or a portion adjacent to the center of the square split pattern in the above range.

In the first embodiment, the end points 31a (32a and 33a) of the arrows respectively representing the split directions of the birefringent plates 31 (32 and 33) form an isosceles triangle when the arrows are superimposed on one another and the end points are connected to one another, as described above. The position (point Pa1) of incidence of the incident beam L thus can be positioned to overlap with the approximate center of the square split pattern (points P11, P12, P13, and P14) easily by selecting the split direction (orientation of the optic axis) of each of the birefringent plates to position each of the birefringent plates so that the end points 31a (32a and 33a) of the arrows for the split directions of the birefringent plates form an isosceles triangle when being connected to one another, in addition to the operations and effects described above.

In the first embodiment, the position (point Pa1) of incidence of the incident beam L on the vertically splitting birefringent plate 31 overlaps with the center of the four pixels 41 of the imaging element 40 when viewed from the incident beam side, as described above. The amount of displacement of the position of incidence of the incident beam L in relation to the center of the four pixels 41 thus can be reduced while the amount of displacement of the position of incidence of the incident beam L from the center of the split pattern is reduced, in addition to the operations and effects described above. Accordingly, Moiré can be reduced while the precision of the position of the split pattern (points P11, P12, P13, and P14) and the positions of the pixels 41 of the imaging element 40 in relation to the position (point Pa1) of incidence of the incident beam L is improved.

In the first embodiment, the lens 20, the vertically splitting birefringent plate 31, the 45° splitting birefringent plate 32, the 135° splitting birefringent plate 33, and the imaging element 40 are disposed in this order starting from the incident beam side, as described above. The imaging device 100 can be thus obtained with improved precision of the position of incidence of the incident beam L from the object side in relation to the position of the center of the four pixels 41 of the imaging element 40, and, if the imaging device 100 is installed as an onboard camera on a car, the positions of traffic lane lines, road signs, pedestrians, and other objects around the car can be more accurately recognized, in addition to the operations and effects described above.

### SECOND EMBODIMENT

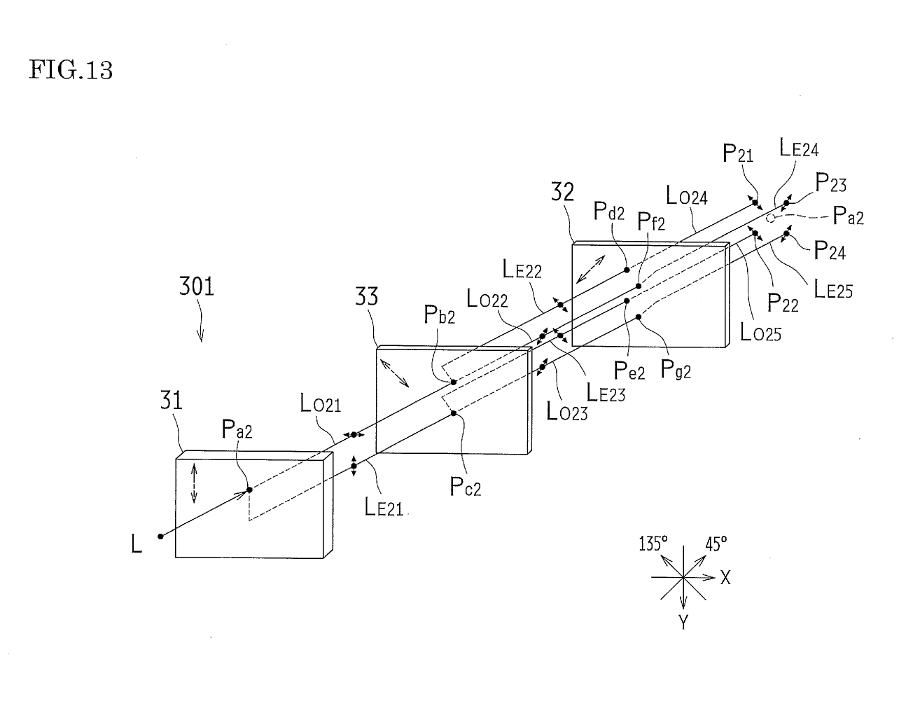

Next, a second embodiment will be described with reference to FIG. 13 to FIG. 17. This second embodiment differs from the first embodiment described above in the order of arrangement of the birefringent plates starting from the incident beam side.

In an optical low-pass filter 301 according to the second embodiment, as shown in FIG. 13, the vertically splitting birefringent plate 31, the 135° splitting birefringent plate 33, and the 45° splitting birefringent plate 32 are adjacent to one another in this order starting from the incident beam side.

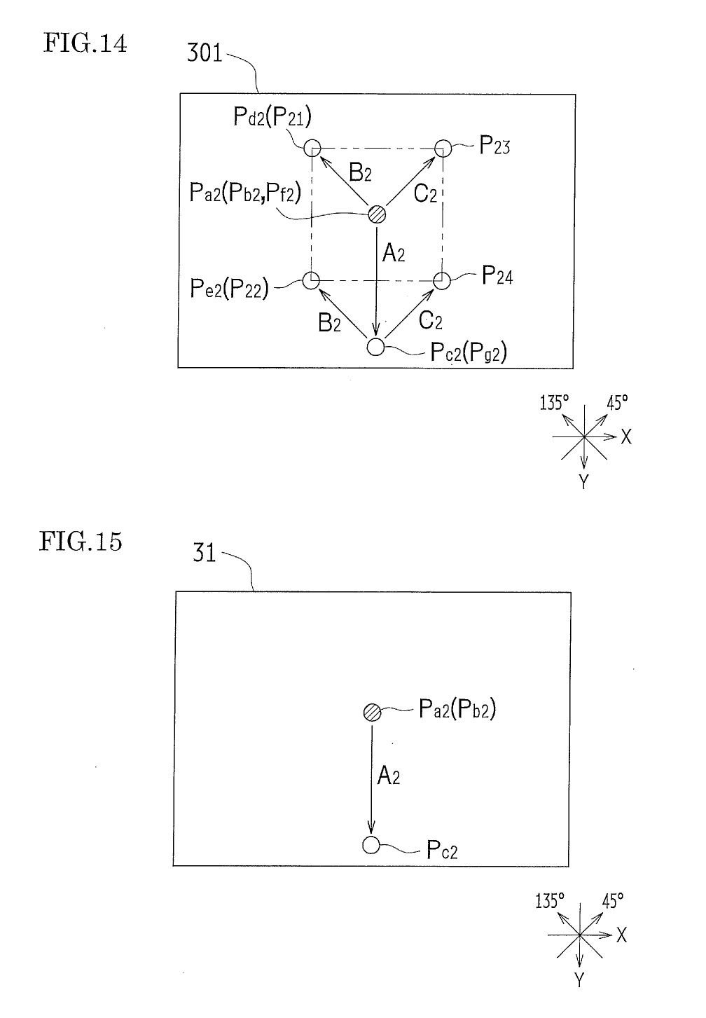

Next, splitting by the optical low-pass filter 301 will be described. As shown in FIG. 13, the incident beam L on a point Pa2 on the vertically splitting birefringent plate 31 is split by birefringence into two beams (unit beams), an ordinary beam LO21 and an extraordinary beam LE21. In this case, the extraordinary beam LE21 is split in the vertical direction (Y direction). In other words, as shown in FIG. 14 and FIG. 15, the beam (shaded portion) incident on the point Pa2 is split in the direction of the arrow A2 (vertical direction) into beams on two points (points Pb2 and Pc2). As shown in FIG. 13, the orientation of the plane of polarization of the ordinary beam LO21 is the horizontal direction (X direction), and the orientation of the plane of polarization of the extraordinary beam LE21 is the vertical direction (Y direction).

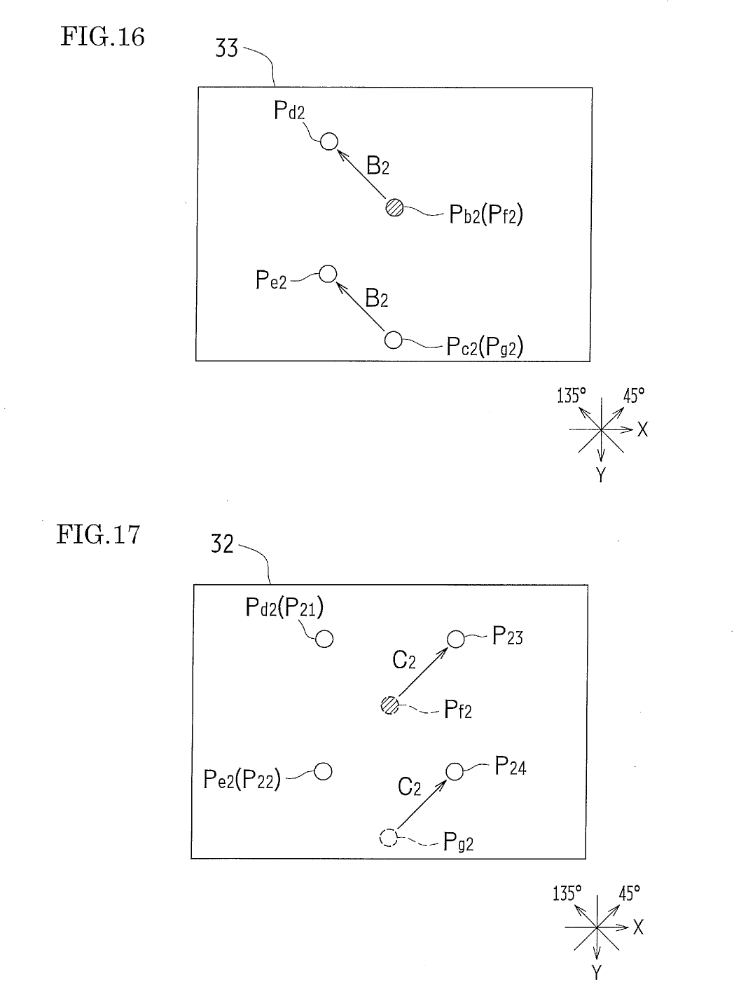

Next, the ordinary beam LO21 incident on a point Pb2 on the 135° splitting birefringent plate 33 is split by birefringence into two beams (unit beams), an ordinary beam LO22 and an extraordinary beam LE22. In this case, the extraordinary beam LE22 is split in the 135° direction. The extraordinary beam LE21 incident on the point Pc2 on the 135° splitting birefringent plate 33 is split by birefringence into two beams (unit beams), an ordinary beam LO23 and an extraordinary beam LE23. In this case, the extraordinary beam LE23 is split in the 135° direction. In other words, as shown in FIG. 14 and FIG. 16, the beams incident on the points Pb2 and Pc2 are each split in the direction of the arrows B2 (135° direction), and thus the beams are split into beams on four points (points Pd2, Pe2, Pf2, and Pg2). As shown in FIG. 13, the orientations of the planes of polarization of the ordinary beam LO22 and the ordinary beam LO23 are both the 45° direction, and the orientations of the planes of polarization of the extraordinary beam LE22 and the extraordinary beam LE23 are both the 135° direction.

Next, the extraordinary beam LE22 incident on the point Pd2 on the 45° splitting birefringent plate 32 is emitted as an ordinary beam LO24 (point P21). Similarly, the extraordinary beam LE23 incident on the point Pe2 on the 45° splitting birefringent plate 32 is emitted as an ordinary beam LO25 (point P22). On the other hand, the ordinary beam LO22 incident on the point Pf2 on the 45° splitting birefringent plate 32 is shifted in the 45° direction and emitted as an extraordinary beam LE24 (point P23). Similarly, the ordinary beam LO23 incident on the point Pg2 on the 45° splitting birefringent plate 32 is shifted in the 45° direction and emitted as an extraordinary beam LE25 (point P24). In other words, as shown in FIG. 14 and FIG. 17, the beams incident on the points Pf2 and Pg2 are each shifted in the direction of the arrows C2 (45° direction), and thus beams on four points (points P21, P22, P23, and P24) are emitted. As shown in FIG. 13, the orientations of the planes of polarization of the ordinary beam LO24 and the ordinary beam LO25 are both the 135° direction, and the orientations of the planes of polarization of the extraordinary beam LE24 and the extraordinary beam LE25 are both the 45° direction.

Accordingly, the incident beam L is split into four outgoing beams (unit beams) positioned at corners of a square split pattern constituted of the points P21, P22, P23, and P24. In the second embodiment, as shown in FIG. 13 and FIG. 14, the position (point Pa2) of incidence of the incident beam L (shaded portion in FIG. 14) on the vertically splitting birefringent plate 31 overlaps with the center of the square split pattern when viewed from the incident beam side toward the outgoing beam side. Specifically, the position (point Pa2) of incidence of the incident beam L overlaps with the intersection point of the diagonal line connecting the point P21 and the point P24 and the diagonal line connecting the point P22 and the point P23 of the split pattern.

The other configurations and effects of the second embodiment are the same as the configurations and effects of the first embodiment described above.

### THIRD EMBODIMENT

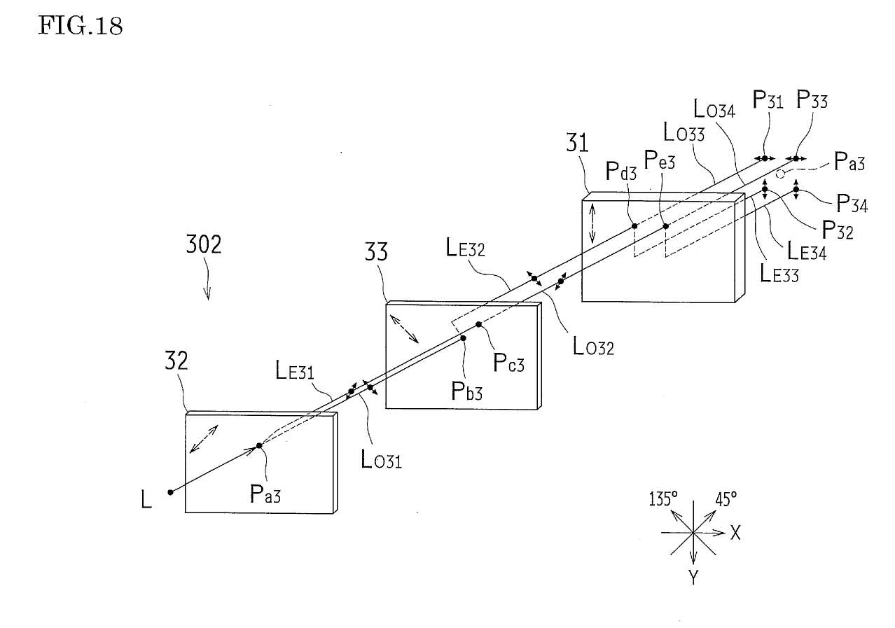

Next, a third embodiment will be described with reference to FIG. 18 to FIG. 22. This third embodiment differs from the first and the second embodiments described above in the order of arrangement of the birefringent plates starting from the incident beam side.

In an optical low-pass filter 302 according to the third embodiment, as shown in FIG. 18, the 45° splitting birefringent plate 32, the 135° splitting birefringent plate 33, and the vertically splitting birefringent plate 31 are adjacent to one another in this order starting from the incident beam side.

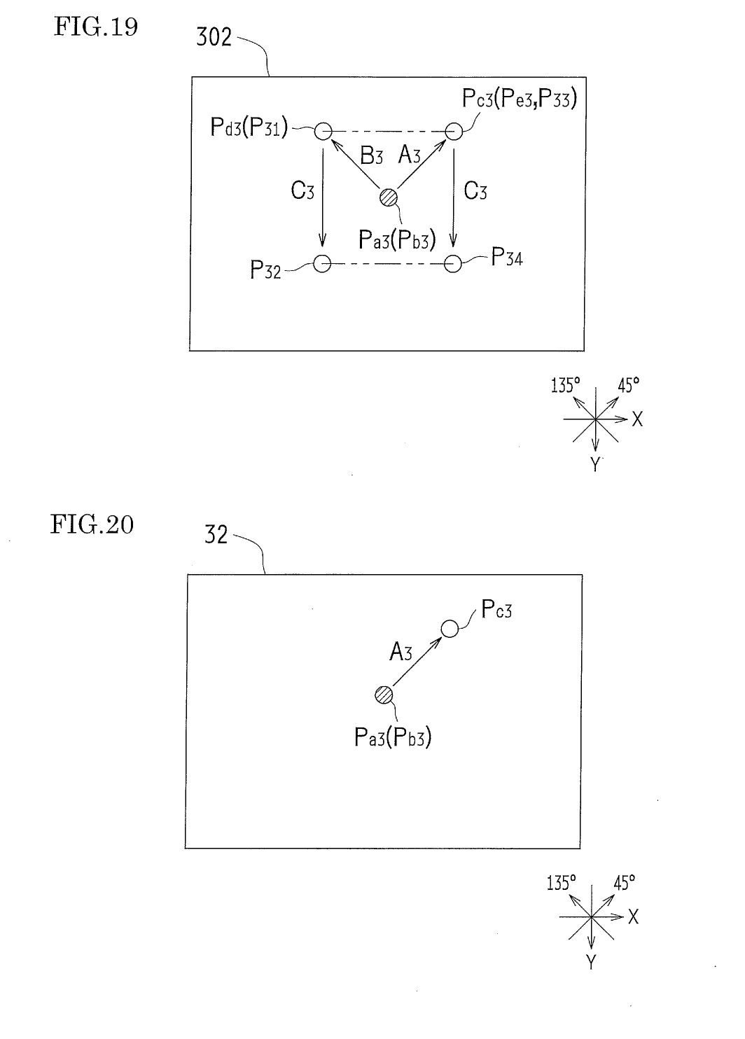

Next, splitting by the optical low-pass filter 302 will be described. As shown in FIG. 18, the incident beam L on a point Pa3 on the 45° splitting birefringent plate 32 is split by birefringence into two beams (unit beams), an ordinary beam LO31 and an extraordinary beam LE31. In this case, the extraordinary beam LE31 is split in the 45° direction. In other words, as shown in FIG. 19 and FIG. 20, the beam (shaded portion) incident on the point Pa3 is split in the direction of the arrow A3 (45° direction) into beams on two points (points Pb3 and Pc3). As shown in FIG. 18, the orientation of the plane of polarization of the ordinary beam LO31 is the 135° direction, and the orientation of the plane of polarization of the extraordinary beam LE31 is the 45° direction.

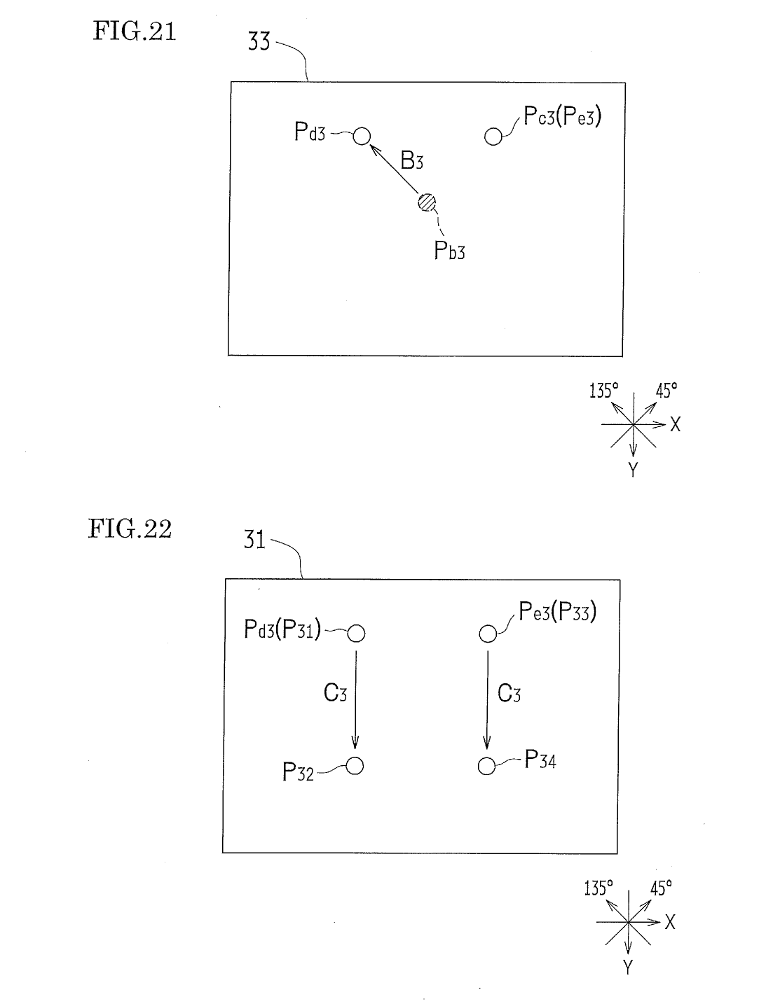

Next, the ordinary beam LO31 incident on the point Pb3 on the 135° splitting birefringent plate 33 is shifted in the 135° direction and emitted as an extraordinary beam LE32. The extraordinary beam LE31 incident on the point Pc3 on the 135° splitting birefringent plate 33 is emitted as an ordinary beam LO32. In other words, as shown in FIG. 19 and FIG. 21, the beam incident on the point Pb3 is shifted in the direction of the arrow B3 (135° direction), and beams on two points (points Pd3 and Pe3) are emitted. As shown in FIG. 18, the orientation of the plane of polarization of the ordinary beam LO32 is the 45° direction, and the orientation of the plane of polarization of the extraordinary beam LE32 is the 135° direction.

Next, as shown in FIG. 18, the extraordinary beam LE32 incident on the point Pd3 on the vertically splitting birefringent plate 31 is split by birefringence into two beams (unit beams), an ordinary beam LO33 and an extraordinary beam LE33. In this case, the extraordinary beam LE33 is split in the vertical direction (Y direction). The ordinary beam LO33 is emitted on a point P31, and the extraordinary beam LE33 is emitted on a point P32. The ordinary beam LO32 incident on a point Pe3 on the vertically splitting birefringent plate 31 is split by birefringence into two beams (unit beams), an ordinary beam LO34 and an extraordinary beam LE34. In this case, the extraordinary beam LE34 is split in the vertical direction (Y direction). The ordinary beam LO34 is emitted on a point P33, and the extraordinary beam LE34 is emitted on a point P34. In other words, as shown in FIG. 19 and FIG. 22, the beams incident on the points Pd3 and Pe3 are each split in the direction of the arrows C3 (vertical direction), and thus the beams are split into beams on four points (points P31, P32, P33, and P34). As shown in FIG. 18, the orientations of the planes of polarization of the ordinary beam LO33 and the ordinary beam LO34 are both the horizontal direction (X direction), and the orientations of the planes of polarization of the extraordinary beam LE33 and the extraordinary beam LE34 are both the vertical direction (Y direction).

Accordingly, the incident beam L is split into four outgoing beams (unit beams) positioned at corners of a square split pattern constituted of the points P31, P32, P33, and P34. In the third embodiment, as shown in FIG. 18 and FIG. 19, the position Pa3 of incidence of the incident beam L (shaded portion in FIG. 19) on the 45° splitting birefringent plate 32 overlaps with the center of the square split pattern when viewed from the incident beam side toward the outgoing beam side. Specifically, the position (point Pa3) of incidence of the incident beam L overlaps with the intersection point of the diagonal line connecting the point P31 and the point P34 and the diagonal line connecting the point P32 and the point P33 of the split pattern.

In the first and the second embodiments described above, the incident beam is shifted to the outside of the square split pattern when being split by the vertically splitting birefringent plate 31, as shown in FIG. 3 and FIG. 14. In the third embodiment, however, the beam is split and shifted inside the square split pattern, as shown in FIG. 19.

The other configurations and effects of the third embodiment are the same as the configurations and effects of the first and the second embodiments described above.

### FOURTH EMBODIMENT

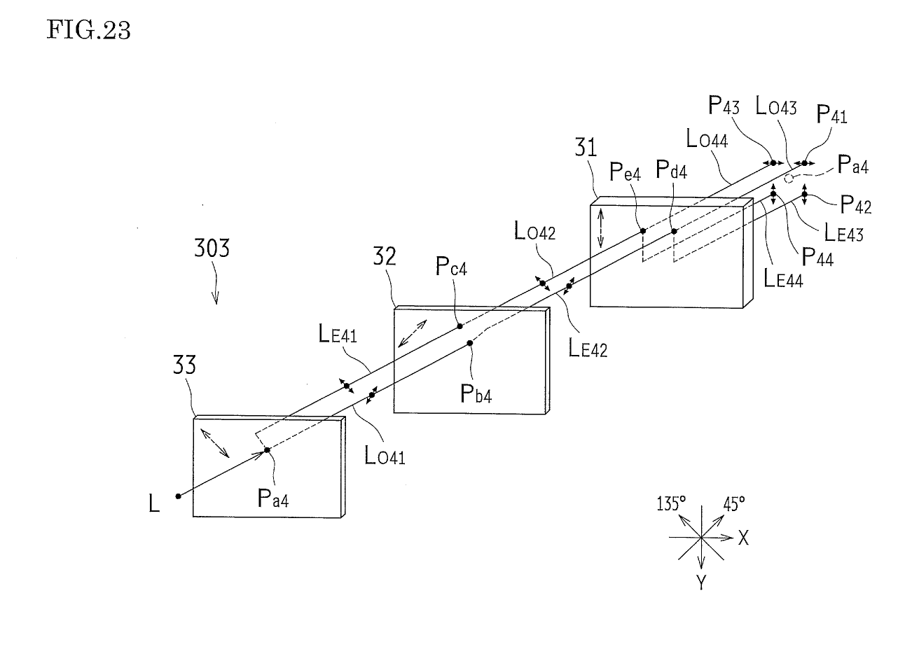

Next, a fourth embodiment will be described with reference to FIG. 23 to FIG. 27. This fourth embodiment differs from the first to the third embodiments described above in the order of arrangement of the birefringent plates starting from the incident beam side.

In an optical low-pass filter 303 according to the fourth embodiment, as shown in FIG. 23, the 135° splitting birefringent plate 33, the 45° splitting birefringent plate 32, and the vertically splitting birefringent plate 31 are adjacent to one another in this order starting from the incident beam side.

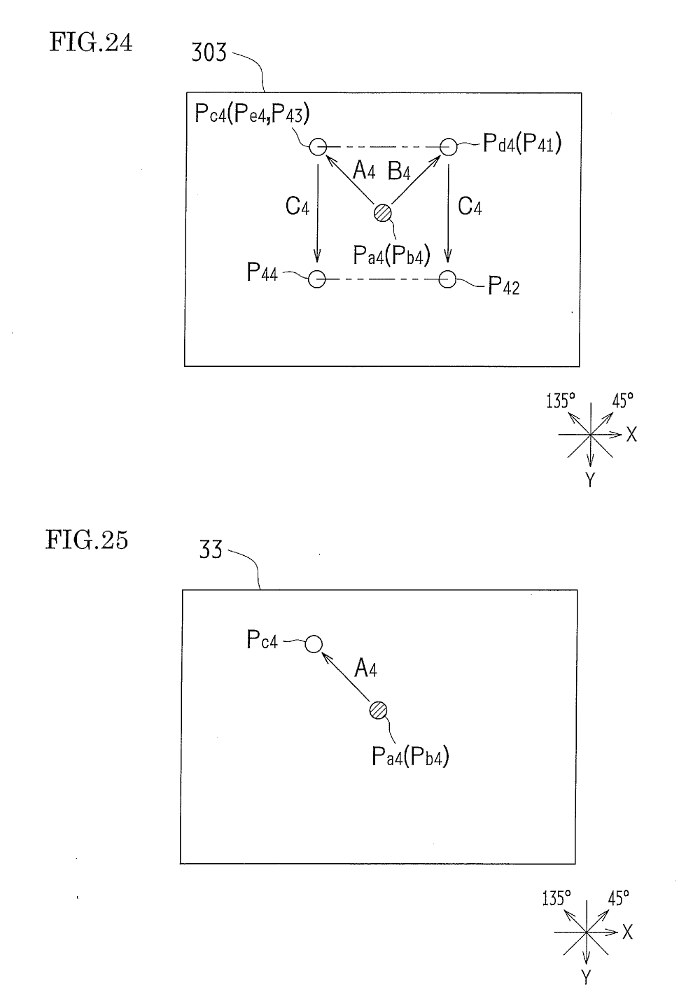

Next, splitting by the optical low-pass filter 303 will be described. As shown in FIG. 23, the incident beam L on a point Pa4 on the 135° splitting birefringent plate 33 is split by birefringence into two beams (unit beams), an ordinary beam LO41 and an extraordinary beam LE41. In other words, as shown in FIG. 24 and FIG. 25, the beam (shaded portion) incident on the point Pa4 is split in the direction of the arrow A4 (135° direction) into beams on two points (points Pb4 and Pc4). As shown in FIG. 23, the orientation of the plane of polarization of the ordinary beam LO41 is the 45° direction, and the orientation of the plane of polarization of the extraordinary beam LE41 is the 135° direction.

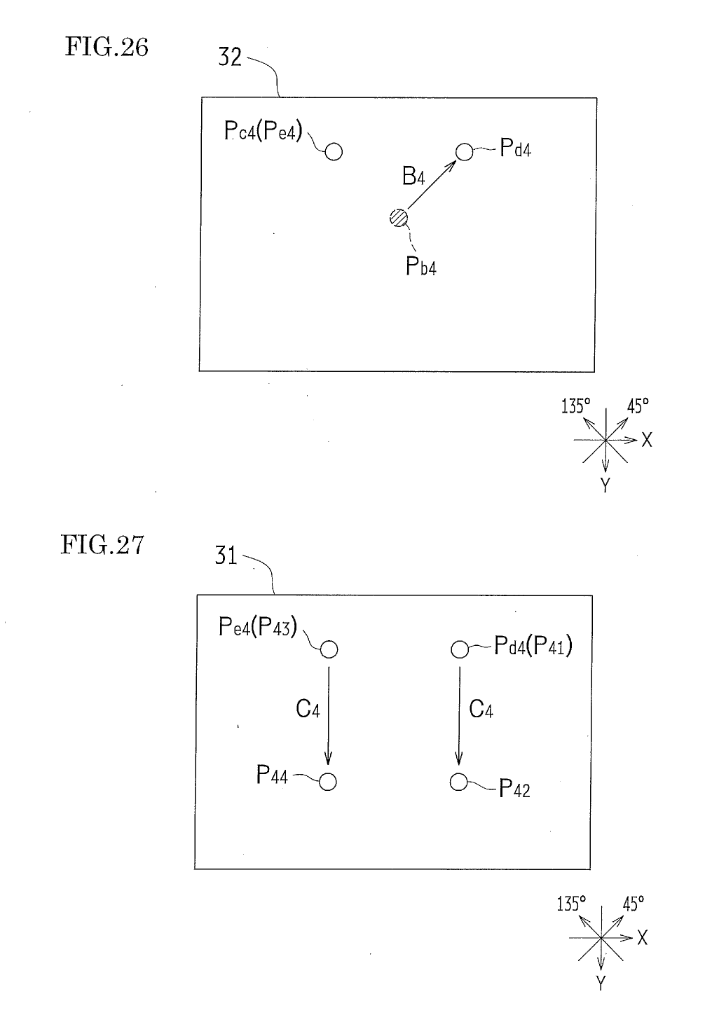

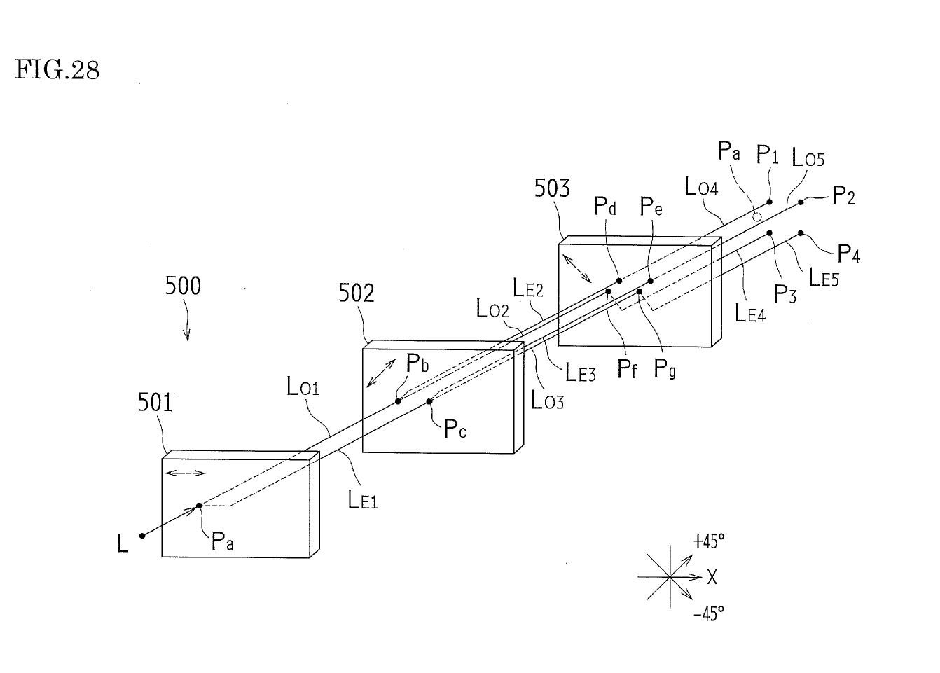

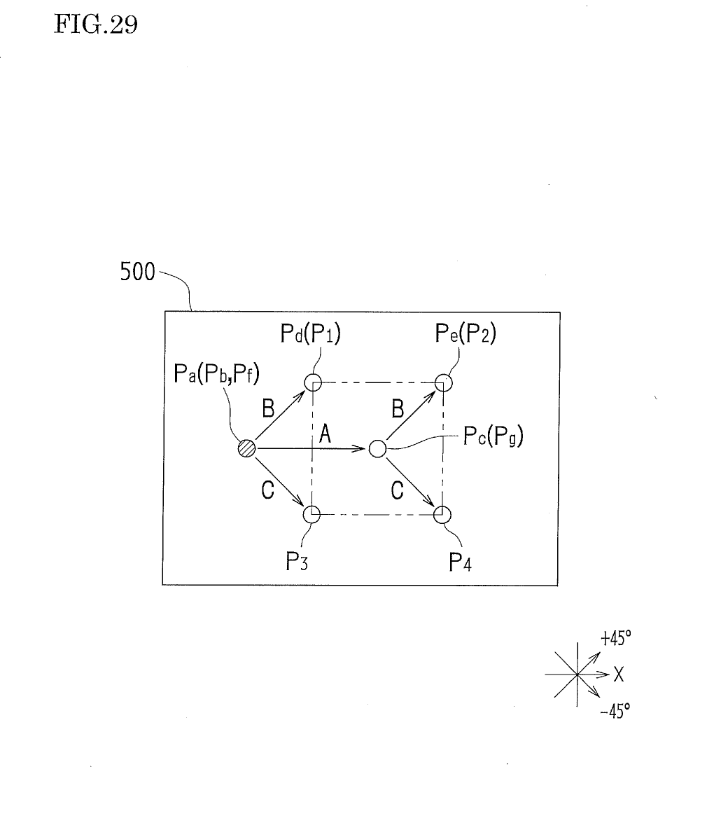

Next, the ordinary beam LO41 incident on the point Pb4 on the 45° splitting birefringent plate 32 is shifted in the 45° direction and emitted as an extraordinary beam LE42. The extraordinary beam LE41 incident on the point Pc4 on the 45° splitting birefringent plate 32 is emitted as an ordinary beam LO42. In other words, as shown in FIG. 24 and FIG. 26, the beam incident on the point Pb4 is shifted in the direction of the arrow B4 (45° direction), and beams on two points (points Pd4 and Pe4) are emitted. As shown in FIG. 23, the orientation of the plane of polarization of the extraordinary beam LE42 is the 45° direction, and the orientation of the plane of polarization of the ordinary beam LO42 is the 135° direction.

Next, the extraordinary beam LE42 incident on the point Pd4 on the vertically splitting birefringent plate 31 is split by birefringence into two beams (unit beams), an ordinary beam LO43 and an extraordinary beam LE43. In this case, the extraordinary beam LE43 is split in the vertical direction (Y direction). The ordinary beam LO43 is emitted on a point P41, and the extraordinary beam LE43 is emitted on a point P42. The ordinary beam LO42 incident on the point Pe4 on the vertically splitting birefringent plate 31 is split by birefringence into two beams (unit beams), an ordinary beam LO44 and an extraordinary beam LE44. In this case, the extraordinary beam LE44 is split in the vertical direction (Y direction). The ordinary beam LO44 is emitted on a point P43, and the extraordinary beam LE44 is emitted on a point P44. In other words, as shown in FIG. 24 and FIG. 27, the beams incident on the points Pd4 and Pe4 are each split in the direction of the arrows C4 (vertical direction), and thus the beams are split into beams on four points (points P41, P42, P43, and P44). As shown in FIG. 23, the orientations of the planes of polarization of the ordinary beam LO43 and the ordinary beam LO44 are both the horizontal direction (X direction), and the orientations of the planes of polarization of the extraordinary beam LE43 and the extraordinary beam LE44 are both the vertical direction (Y direction).

Accordingly, the incident beam L is split into four outgoing beams (unit beams) positioned at corners of a square split pattern constituted of the points P41, P42, P43, and P44. In the fourth embodiment, as shown in FIG. 23 and FIG. 24, the position Pa4 of incidence of the incident beam L (shaded portion in FIG. 24) on the 135° splitting birefringent plate 33 overlaps with the center of the square split pattern when viewed from the incident beam side toward the outgoing beam side. Specifically, the position (point Pa4) of incidence of the incident beam L overlaps with the intersection point of the diagonal line connecting the point P41 and the point P44 and the diagonal line connecting the point P42 and the point P43 of the split pattern.

In the first and the second embodiments described above, as shown in FIG. 3 and FIG. 14, the incident beam is shifted to the outside of the square split pattern when being split by the vertically splitting birefringent plate 31. In the fourth embodiment, however, the beam is split and shifted inside the square split pattern, as shown in FIG. 24.

The other configurations and effects of the fourth embodiment are the same as the configurations and effects of the first to the third embodiments described above.

### OTHER EMBODIMENTS

The embodiments herein have been disclosed by way of example only in every viewpoint and should be deemed to be not limiting. The scope of the present invention is defined not by the description of the embodiments above but by claims and includes every modification within the meaning and the scope equivalent to the scope of the claims.

For example, the first to the fourth embodiments have described examples in which the optical low-pass filter in combination with the lens and the imaging element is used as the imaging device, but the present invention is not limited to these examples. For example, the optical low-pass filter may be used singly, or the optical low-pass filter can be applied to a device other than imaging devices.

The first to the fourth embodiments have described examples in which the square split pattern is obtained, but the present invention is not limited to these examples. For example, the split pattern may have a quadrangular shape other than square shapes as long as the position of incidence of the incident beam is positioned at the approximate center or a portion adjacent to the center of the split pattern.

The first to the fourth embodiments have described examples in which the birefringent plates having rectangular major surfaces are applied, but the present invention is not limited to these examples. For example, square or polygonal birefringent plates may be applied instead of the rectangular birefringent plates. The shapes of the birefringent plates may be different from one another.

The first to the fourth embodiments have described examples in which the vertically splitting birefringent plate is applied as an example of the first birefringent plate, but the present invention is not limited to these examples. For example, a horizontally splitting birefringent plate may be applied as an example of the first birefringent plate. In this case, it is preferred to set the split direction of the second birefringent plate to be a direction at 135° counterclockwise to the split direction (horizontal direction) of the first birefringent plate and to set the split direction of the third birefringent plate to be a direction at 135° clockwise to the split direction (horizontal direction) of the first birefringent plate.

### INDUSTRIAL APPLICABILITY

The present invention can be used in an optical low-pass filter and an imaging device and, more particularly, in an optical low-pass filter including three birefringent plates configured to split an incident beam into four outgoing beams positioned at corners of a quadrangular split pattern, and an imaging device.

### REFERENCE SIGNS LIST

20 Lens (Coupling optical unit)
30, 301, 302, and 303 Optical low-pass filter
31 Vertically splitting birefringent plate (First birefringent plate)
32 45° Splitting birefringent plate (Second birefringent plate)
33 135° Splitting birefringent plate (Third birefringent plate)
40 Imaging element
41 Pixel
100 Imaging device

1. An optical low-pass filter comprising three birefringent plates, the three birefringent plates being configured to split an incident beam into four outgoing beams positioned at corners of a quadrangular split pattern,
wherein the three birefringent plates comprises:
a first birefringent plate configured to split the incident beam in a vertical direction or a horizontal direction;
a second birefringent plate configured to perform splitting in a direction at 135° counterclockwise to the split direction of the first birefringent plate; and
a third birefringent plate configured to perform splitting in a direction at 135° clockwise to the split direction of the first birefringent plate,
wherein the second birefringent plate and the third birefringent plate are adjacent to each other,
wherein a thickness of the second birefringent plate is approximately equal to a thickness of the third birefringent plate,
wherein the thickness of the second birefringent plate and the thickness of the third birefringent plate are each less than a thickness of the first birefringent plate, and
wherein a position of incidence of the incident beam on the birefringent plates overlaps with an approximate center or a portion adjacent to a center of the quadrangular split pattern when viewed from an incident beam side.

2. The optical low-pass filter according to claim 1,
wherein the thickness of the second birefringent plate and the thickness of the third birefringent plate are each (1/√12) times as large as the thickness of the first birefringent plate,
wherein the incident beam is split by the three birefringent plates into four outgoing beams positioned at corners of a square split pattern, and
wherein the position of incidence of the incident beam on the birefringent plates overlaps with an approximate center of the square split pattern when viewed from the incident beam side.

3. The optical low-pass filter according to claim 1,
wherein end points of arrow-shaped symbols respectively representing the split direction of the first birefringent plate, the split direction of the second birefringent plate, and the split direction of the third birefringent plate form an approximate triangle when the arrow-shaped symbols are superimposed on one another and the end points are coupled to one another.

4. An imaging device comprising:
the optical low-pass filter according to claim 1; and
an imaging element comprising at least four pixels arranged along a row direction and a column direction,
wherein the four outgoing beams split by the three birefringent plates are respectively emitted toward four pixels of the imaging element, and
wherein the position of incidence of the incident beam on the birefringent plates overlaps with an approximate center or a portion adjacent to a center of the four pixels of the imaging element when viewed from the incident beam side.

5. The imaging device according to claim 4, the imaging device further comprising a coupling optical unit that the incident beam is configured to enter,
wherein the coupling optical unit, the three birefringent plates, and the imaging element are disposed in this order starting from the incident beam side.
